(19) United States
(12) Patent Application Publication
(10) Pub. No.: US 2026/0168583 A1
(43) Pub. Date: Jun. 18, 2026

(54) CHECK VALVE AND REFRIGERATOR HAVING SAME

(71) Applicant: Samsung Electronics Co., Ltd., Suwon-si (KR)

(72) Inventors: Seulchan CHU, Suwon-si (KR); Juik OH, Suwon-si (KR); Seulong KO, Suwon-si (KR); Sungwook KIM, Suwon-si (KR); Jeonghyeon YANG, Suwon-si (KR); Sungmin YOO, Suwon-si (KR); Youngchan YOON, Suwon-si (KR)

(73) Assignee: Samsung Electronics Co., Ltd., Suwon-si (KR)

(21) Appl. No.: 19/533,649

(22) Filed: Feb. 9, 2026

Related U.S. Application Data
(63) Continuation of application No. PCT/KR2024/009499, filed on Jul. 4, 2024.

(30) Foreign Application Priority Data
Aug. 28, 2023 (KR) 10-2023-0113208

(51) Int. Cl. F16K 15/06; F25D 11/02

(52) U.S. Cl. CPC F16K 15/06; F25D 11/022

(57) ABSTRACT

A refrigerator includes a check valve provided in the outlet pipe and configured to prevent backflow from the outlet pipe to the first evaporator; and a valve provided in the outlet pipe and configured to prevent backflow from the outlet pipe to the first evaporator. The check valve includes a valve housing comprising an inlet, an outlet, and a guide channel through which the refrigerant flows and a core configured to move back and forth in the valve housing to allow a flow of the refrigerant from the inlet to the outlet and to block a flow of the refrigerant from the outlet to the inlet. The valve housing includes a side opening formed on a side surface of the valve housing. At least a portion of the core is received in the guide channel of the valve housing through the side opening.

### CROSS-REFERENCE TO RELATED APPLICATIONS

This application is a bypass continuation application of International Patent Application No. PCT/KR 2024/009499, filed on Jul. 4, 2024, which claims priority to and is based on Korean Patent Application No. 10-2023-0113208, filed on Aug. 28, 2023, the disclosures of which are incorporated herein in their entireties by reference.

### 1. FIELD

The disclosure relates to a check valve applicable to a refrigerator.

### 2. DESCRIPTION OF RELATED ART

A refrigerator is a device that cools food and the like by discharging cold air generated by a refrigeration cycle to lower the temperature inside a storage compartment.

The refrigeration cycle is a process in which a refrigerant repeatedly becomes a gas and then becomes a liquid again. The process is divided into a compression process in a compressor, a condensation and heat release process in a condenser, an expansion process through a capillary, and an evaporation process in an evaporator, and these processes are connected to each other to perform refrigerating and freezing.

The compressor is used to operate the evaporator, and at this time, a phenomenon of refrigerant backflow may occur due to the difference in evaporation pressure inside a refrigerant pipe.

### SUMMARY

Provided is a refrigerator including a check valve that may prevent backflow of refrigerant.

Further, provided is a refrigerator including a simplified check valve that may have a simple configuration and easy assembly.

Further still, provided is a refrigerator including a check valve that may reduce noise generated when opening and closing a flow path.

According to an aspect of the disclosure, a refrigerator includes: a main body comprising a freezing compartment and a refrigerating compartment; a compressor; a condenser; a first evaporator provided in the freezing compartment and configured to cool the freezing compartment; a second evaporator provided in the refrigerating compartment and configured to cool the refrigerating compartment; an outlet pipe connected to an outlet of the first evaporator and configured to transfer a refrigerant passing through the first evaporator to the compressor; and a check valve provided in the outlet pipe and configured to prevent backflow from the outlet pipe to the first evaporator. The check valve may include a valve housing comprising an inlet, an outlet, and a guide channel through which the refrigerant flows; and a core configured to move back and forth in the valve housing to allow a flow of the refrigerant from the inlet to the outlet and to block a flow of the refrigerant from the outlet to the inlet. The valve housing may include a side opening formed on a side surface of the valve housing. The at least a portion of the core may be received in the guide channel of the valve housing through the side opening.

The inlet may be closer to a bottom surface of the main body than the outlet.

The valve housing may include an inlet body in which the inlet is formed; an outlet body in which the outlet is formed; and a connecting body connecting the inlet body and the outlet body.

The core may include a plate configured to be contactable with the inlet body; and a guide pin protruding from the plate in a direction toward the outlet.

The outlet body may include a guide groove formed on an outer surface of the outlet body to receive the guide pin.

The inlet body may include an inlet protrusion protruding in a direction toward the outlet body and configured to contact the plate. The inner diameter of the guide channel at an end of the inlet protrusion may be smaller than diameter of the plate.

The outlet body may include an outlet protrusion extending from the connecting body and configured to contact the plate.

The outlet protrusion may include a plurality of protrusions spaced apart from each other at intervals. The guide channel may include an intermediate flow path formed to allow the refrigerant to flow between each of the plurality of protrusions.

The connecting body may include a first connecting body and a second connecting body. The diameter of the plate may be smaller than a distance between the first connecting body and the second connecting body.

The inlet body may include an inclined surface having a diameter that decreases progressively in a direction from the inlet toward the inlet protrusion.

The core may include a silicone material.

The inlet body may include a coupling groove formed along a perimeter of the inlet body such that the check valve is to be coupled to an interior of the outlet pipe.

The guide pin may be configured to move back and forth in a space formed between an inner surface of the outlet pipe corresponding to the guide groove and the guide groove.

The outlet pipe may include a sealing portion corresponding to the coupling groove to fix the check valve.

The valve housing and the core may include different materials.

According to an aspect of the disclosure, a check valve includes: a valve housing including: an inlet body including an inlet through which refrigerant flows in, an outlet body including an outlet through which refrigerant flows out, a connecting body configured to connect the inlet body and the outlet body, a side opening between the outlet body and the inlet body, and a guide channel through which refrigerant flows; and a core including a plate configured to be able to contact the inlet body and a guide pin connected to the plate, wherein at least a portion of the core is configured to be received in the guide channel through the side opening, and the outlet body further includes a guide groove on an outer surface of the outlet body and configured to receive the guide pin and allow the guide pin to move back and forth.

The inlet body may further include an inlet protrusion protruding in a direction toward the outlet body and configured to contact the plate, and wherein an inner diameter of the guide channel at an end of the inlet protrusion is smaller than a diameter of the plate.

The core may include a silicone material.

The inlet body further may include a coupling groove along a perimeter of the inlet body.

The inlet body may further include the inclined surface having a diameter that decreases progressively in a direction from the inlet toward the outlet.

Technical tasks to be achieved in this document are not limited to the technical tasks mentioned above, and other technical tasks not mentioned will be clearly understood by those skilled in the art from the description below.

According to one or more embodiments of the present disclosure, there is provided the refrigerator including the simplified check valve that may have a simple configuration and easy assembly, and may improve cooling efficiency by preventing the phenomenon of refrigerant backflow in the outlet pipe of the evaporator with the lower pressure among the plurality of evaporators with different evaporation pressures.

According to one or more embodiments of the present disclosure, there is provided a check valve that may have a simple configuration and easy assembly.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is a side cross-sectional view of a refrigerator including a check valve, according to one or more embodiments of the present disclosure;

FIG. 2 is a configuration diagram of a cold air supply device of the refrigerator including the check valve, according to one or more embodiments of the present disclosure;

FIG. 3 is an enlarged partial cross-sectional view of a check valve coupled to an outlet pipe according to one or more embodiments of the present disclosure;

FIG. 4 is an exploded perspective view of the check valve applied to the refrigerator according to one or more embodiments of the present disclosure;

FIG. 5 is an exploded perspective view of the check valve applied to the refrigerator according to one or more embodiments of the present disclosure;

FIG. 6 is an exploded plan view of the check valve applied to the refrigerator according to one or more embodiments of the present disclosure;

FIG. 7 is a partial cross-sectional view showing refrigerant flowing in a forward direction in the check valve applied to the refrigerator according to one or more embodiments of the present disclosure;

FIG. 8 is a partial cross-sectional view showing refrigerant flowing in a reverse direction in the check valve according to one or more embodiments of the present disclosure;

FIG. 9 is a cross-sectional view taken along line A-A of FIG. 7; and

FIG. 10 is a cross-sectional view taken along line B-B of FIG. 7.

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

As used herein, an expression, “a and/or b” should be understood as including only a, only b and both a and b. As used herein, expressions “at least one of a, b, and c” and “at least one of a, b, or c” should be understood as including only a, only b, only c, both a and b, both a and c, both b and c, or all of a, b, and c.

As used herein, the term “and/or” includes any and all combinations of one or more of the associated listed items.

The terms “first,” “second,” “third,” and the like (e.g., primary, secondary) in the description and in the claims, if any, are used for distinguishing between similar elements and not necessarily for describing a sequential or chronological order. It is to be understood that the terms so used are interchangeable under appropriate circumstances.

Recitation of ranges of values herein is merely intended to serve as a shorthand method of referring individually to each separate value falling within the range, unless otherwise indicated. Each separate value is incorporated into the specification as if it were individually recited herein. Also, numerical values are understood to include values that are close to or approximately equal to the stated value, unless otherwise specified. For example, a value of 200 encompasses about or approximately 200 or values close to 200.

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to one or more embodiments of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to one or more embodiments of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to one or more embodiments of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulating material or one or more insulating layers.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to one or more embodiments of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to one or more embodiments, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to one or more embodiments, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to one or more embodiments of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to one or more embodiments of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to one or more embodiments of the disclosure, the cold air supply device may include a semiconductor, such as a thermoelectric element. The thermoelectric element may cool the storage compartment by heating and cooling actions through the Peltier effect.

The refrigerator according to one or more embodiments of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to one or more embodiments of the disclosure may include a dispenser provided on the door to provide water and/or ice. The dispenser may be provided on the door to allow access by the user without opening the door.

The refrigerator according to one or more embodiments of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to one or more embodiments of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like to be used for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to one or more embodiments of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

A check valve 100 according to the concept of the present disclosure is not limited to application to a refrigerator 1 as described above, and may be applied to various types of appliances utilizing a refrigeration cycle.

Hereinafter, one or more embodiments will be described in detail with reference to the accompanying drawings.

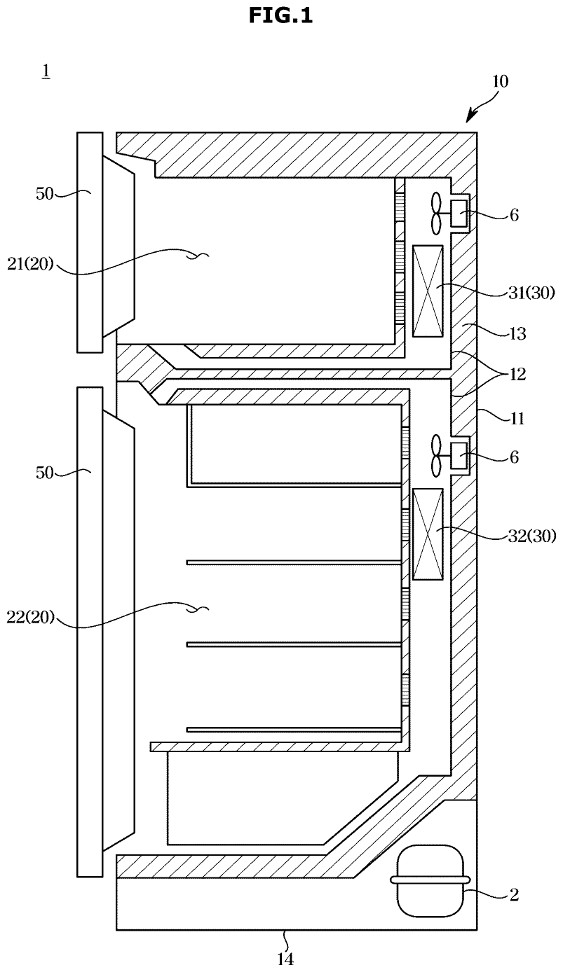

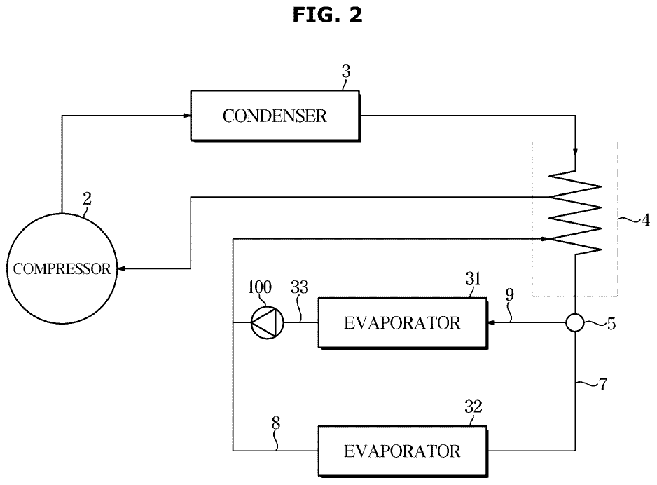

FIG. 1 is a side cross-sectional view of the refrigerator 1 including the check valve 100 according to one or more embodiments of the present disclosure, and FIG. 2 is a configuration diagram of a cold air supply device of the refrigerator 1 including the check valve 100 according to one or more embodiments of the present disclosure.

Referring to FIG. 1, the refrigerator 1 may include a main body 10, a storage compartment 20 formed by partitioning inside the main body 10, a door 50 configured to open or close the storage compartment 20, and a cold air supply device configured to provide cold air to the storage compartment 20.

The main body 10 may include an inner case 12 forming the storage compartment 20, an outer case 11 coupled to an outer side of the inner case 12 to form an exterior, and an insulation foamed between the inner case 12 and the outer case 11 to thermally insulate the storage compartment 20. The inner case 12 may be formed of a plastic material, and the outer case 11 may be formed of a metal material.

A compressor 2 capable of compressing a refrigerant and a condenser 3 capable of condensing the refrigerant compressed by the compressor 2 may be disposed on a rear lower side of the main body 10. The main body 10 may be formed in a substantially cuboidal shape, and may include a bottom surface 14 forming a lower portion of the main body 10. The bottom surface 14 may be disposed substantially parallel to the ground when the refrigerator 1 is installed.

Referring to FIG. 2, the refrigerator 1 may include the cold air supply device comprising the compressor 2, the condenser 3, a capillary 4, and an evaporator 30. The compressor 2 may compress a gaseous refrigerant into a high-temperature, high-pressure gas, and the condenser 3 may convert the high-temperature, high-pressure refrigerant into a liquid refrigerant by releasing heat. The liquid high-pressure refrigerant may be reduced in pressure as it passes through the capillary 4.

The refrigerant that has been reduced in pressure after passing through the capillary 4, may be selectively supplied by a three-way valve 5 disposed in a branch region in which piping that divides into a first evaporator 31 and a second evaporator 32 is installed.

When a branch pipe 7 through which refrigerant may flow to the second evaporator 32 is closed by the three-way valve 5 and an inlet pipe 9 through which refrigerant may flow to the first evaporator 31 is opened, the refrigerant that has passed through the capillary 4 may be supplied to the first evaporator 31. Conversely, when the inlet pipe 9 is closed and the branch pipe 7 is opened, the refrigerant that has passed through the capillary 4 may be supplied to the second evaporator 32.

The refrigerant that has passed through the capillary 4 may flow into the evaporator 30 and be vaporized. The vaporized refrigerant may absorb heat from the surroundings to cool the air around the evaporator 30, and the generated cold air may be blown into the storage compartment 20 of the refrigerator 1 by a blowing fan 6. Then, the vaporized refrigerant may flow into the compressor 2 and may be compressed into a high-temperature, high-pressure gas.

The storage compartment 20 may be formed to be divided into a freezing compartment 21 and a refrigerating compartment 22, and the evaporator 30 may also be arranged with the first evaporator 31 corresponding to the freezing compartment 21 and the second evaporator 32 corresponding to the refrigerating compartment 22.

The three-way valve 5 may be installed in a portion that selectively distributes refrigerant to the first evaporator 31 and the second evaporator 32 via the capillary 4. The depressurized refrigerant passing through the capillary 4 may flow along a flow path and be selectively supplied by the three-way valve 5 installed in a branch region that divides into the first evaporator 31 and the second evaporator 32.

The refrigerant supplied to the first evaporator 31 may be evaporated within the first evaporator 31, and at this time, cold air may be formed as it absorbs heat from the surroundings. Then, the formed refrigerant may be provided back to the compressor 2. The second evaporator 32 may similarly form cold air.

The cold air formed in the first evaporator 31 and the second evaporator 32 may be supplied to the freezing compartment 21 and the refrigerating compartment 22 through corresponding blowing fans 6, respectively.

When refrigerant is supplied from the condenser 3 through the capillary 4 to the evaporator 30, the load on the plurality of evaporators 30 may act differently depending on the temperature difference between the freezing compartment 21 and the refrigerating compartment 22. As the loads of the freezing compartment 21 and the refrigerating compartment 22 act differently, the evaporation pressure of the first evaporator 31 and the evaporation pressure of the second evaporator 32 may be different.

The pressure of the refrigerant in a downstream pipe 8 connected to an outlet that has passed through the branch pipe 7 and the second evaporator 32 by operation of the three-way valve 5 may be higher than the pressure of the refrigerant in an outlet pipe 33. This may cause the refrigerant to flow backward instead of toward the compressor 2.

To address such a problem, the check valve 100 may be disposed in the outlet pipe 33 of the first evaporator 31 to block refrigerant at a high-pressure from flowing backwardly into the first evaporator 31 through the outlet pipe 33 of the first evaporator 31.

The check valve 100 may prevent backflow of refrigerant from the evaporator 30 to the compressor 2, thereby maintaining the flow of refrigerant in one direction.

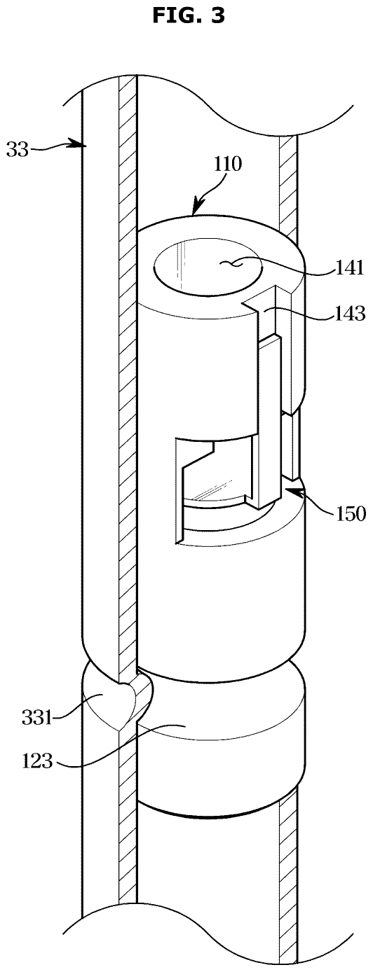

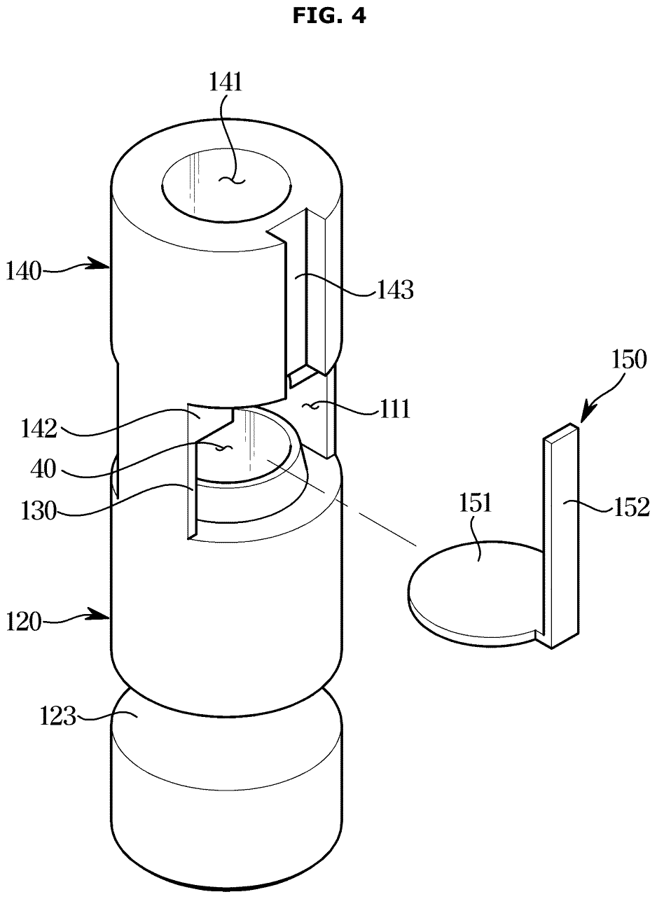

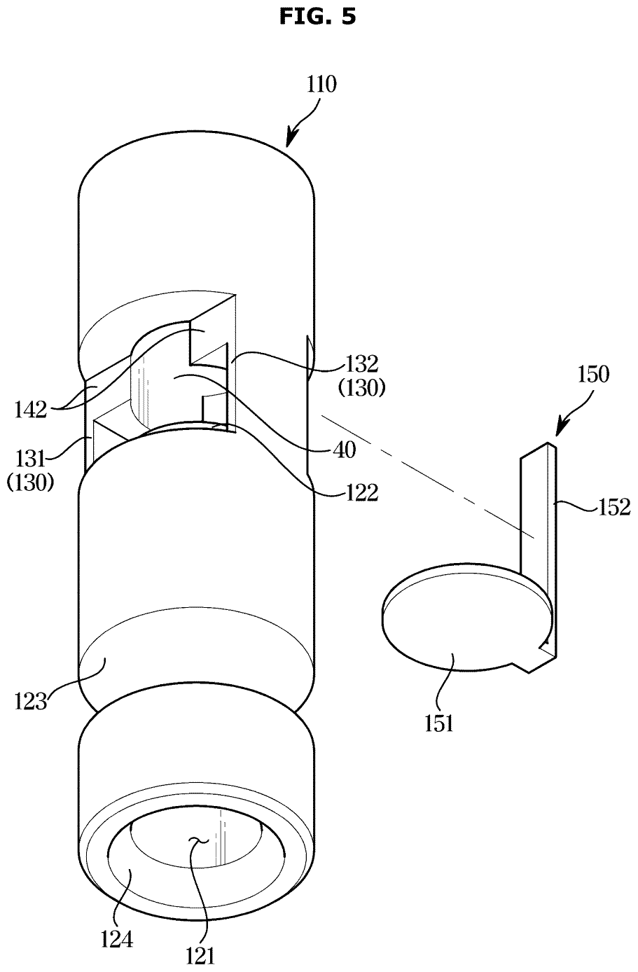

FIG. 3 is an enlarged partial cross-sectional view of the check valve 100 coupled to the outlet pipe 33 according to one or more embodiments of the present disclosure, and FIGS. 4 and 5 are exploded perspective views of the check valve 100 applied to the refrigerator 1 according to one or more embodiments of the present disclosure.

Referring to FIGS. 3 and 4, the check valve 100 may be coupled to the interior of the outlet pipe 33 to maintain the flow of refrigerant in the outlet pipe 33 in one direction.

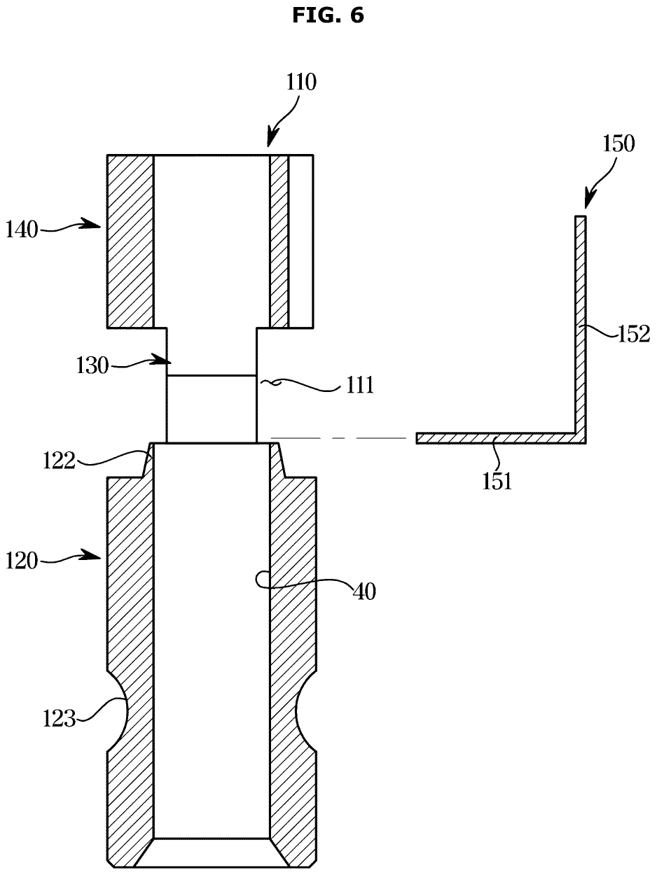

The check valve 100 according to one or more embodiments of the present disclosure may include a valve housing 110 and a core 150. FIG. 3 shows the core 150 in an assembled state with the core 150 inserted through a side opening 111 (see FIG. 6) of the valve housing 110, and inserted into and coupled to the outlet pipe 33. FIG. 4 shows the core 150 without being inserted into the side opening 111 of the valve housing 110, prior to being coupled to the outlet pipe 33.

The valve housing 110 may include an inlet body 120, an outlet body 140, and a connecting body 130 connecting the inlet body 120 and the outlet body 140. The side opening 111, into which the core 150 may be inserted, may be formed on a side surface of the valve housing 110 in the same plane as the connecting body 130.

The refrigerant that has passed through the first evaporator 31 may enter through an inlet 121 of the check valve 100 and exit through an outlet 141. At this time, the refrigerant passing therethrough may in turn pass through the inlet body 120, the connecting body 130, and the outlet body 140, which are configurations of the valve housing 110.

The inlet body 120 may include an inlet protrusion 122 having a shape protruding toward the outlet body 140, and the outlet body 140 may include an outlet protrusion 142 having a shape protruding toward the inlet protrusion 122.

When the valve housing 110 is coupled to the interior of the outlet pipe 33, a guide channel 40, which is a space allowing refrigerant to flow from the inlet 121 to the outlet 141, may be formed.

The core 150, which is inserted through the side opening 111 of the valve housing 110, may include a plate 151 capable of blocking the guide channel 40 and a guide pin 152 capable of guiding movement of the plate 151 to allow the plate 151 to block the guide channel 40.

To block the flow of refrigerant when refrigerant flows from the outlet 141 to the inlet 121 (reverse direction), rather than when refrigerant flows from the inlet 121 to the outlet 141 side (forward direction), an inner diameter of the guide channel 40 formed in the inlet protrusion 122 may be formed to be smaller than a diameter of the plate 151.

Although the plate 151 is shown in FIG. 4 as a disk-shaped plate 151, the plate 151 does not necessarily have to be formed in a disk shape, and it is sufficient as long as it is formed in a shape capable of blocking the flow of refrigerant.

In the absence of refrigerant flow, the core 150 may maintain a state of being in contact with the inlet protrusion 122 by gravity. At this time, the plate 151 of the core 150 may cause a refrigerant flow path 40 of the inlet body 120 to be closed.

To allow the core 150 to be influenced by gravity toward the inlet body 120 side, the inlet 121 may be formed closer to the bottom surface 14 than the outlet 141 when the check valve 100 is disposed in the outlet pipe 33 inside the refrigerator 1. The core 150 may be provided such that the plate 151, under the influence of gravity, blocks the refrigerant flow path 40 of the inlet body 120, thereby preventing refrigerant from flowing in the reverse direction to the check valve 100. However, the check valve 100 may not be positioned perpendicular to the ground, and it is sufficient that the core 150 may contact the inlet body 120 when no refrigerant is flowing.

The valve housing 110 may be formed of a material that is not deformed by the temperature or pressure of the refrigerant. As the core 150 moves back and forth (e.g., reciprocate) inside the valve housing 110 to open or close the refrigerant flow path 40, noise may be generated as the core 150 collides with the valve or the core 150 collides with the outlet pipe 33.

To address the technical problem, the core 150 may be formed of a nylon material. The core 150 may be formed of PA66. However, it is not necessarily limited to such a material, and it is sufficient as long as it is formed of a material that may generate less noise.

The inlet body 120 of the valve housing 110 may be formed with a coupling groove 123 for coupling to the interior of the outlet pipe 33. Further, the outlet pipe 33 may include a corresponding sealing portion 331. After the check valve 100 with the core 150 inserted inside the valve housing 110 is inserted into the interior of the outlet pipe 33, pressure may be applied from the outside of the outlet pipe 33 on a side of the sealing portion 331 corresponding to the coupling groove 123, so that the check valve 100 is fixedly coupled. This may prevent refrigerant from flowing between an outer surface of the valve housing 110 and an inner surface of the outlet pipe 33.

However, the check valve 100 and the outlet pipe 33 may not be be coupled via the coupling groove 123 and the sealing portion 331. For example, the check valve 100 may be fixed within the outlet pipe 33 in a manner where sealing portions 331 are formed at both ends of the valve housing 110 and the check valve 100 is fixed between a plurality of sealing portions 331.

The outlet body 140 may include a guide groove 143 formed on an outer surface of the outlet body 140 in a grooved shape to allow the guide pin 152 of the core 150 to move back and forth. The guide groove may correspond with a portion of the inner surface of the outlet pipe 33 and allow the core 150 to move smoothly in a position at which the core 150 may open or close the refrigerant flow path 40. The guide groove 143 may be formed wider than a thickness of the guide pin 152 to allow the guide pin 152 to move smoothly.

When the connecting body 130 is formed in a shape that completely encloses the outer surface of the valve housing 110, except for the side opening 111 disposed between the inlet body 120 and the outlet body 140, it may impede the back-and-forth movement of the core 150.

To address such a problem, referring to FIG. 5, the connecting body 130 may be formed in a shape of a plurality of columns to connect the inlet body 120 and the outlet body 140. However, the connecting body 130 may not beformed in a shape of two columns as shown in the drawings, and it is sufficient as long as it is formed to reliably connect the inlet body 120 and the outlet body 140 to withstand the pressure of the refrigerant and not impede movement of the core 150.

The connecting body 130 may be connected to the outlet protrusion 142 of the outlet body 140. The outlet protrusion 142 may be formed to allow refrigerant to pass along a perimeter of the plate 151 when the plate 151 contacts the outlet protrusion 142. A separation space 112 may be formed between the outer surface of the valve housing 110 and an outer circumferential surface of the plate 151 at a certain distance to allow refrigerant to flow.

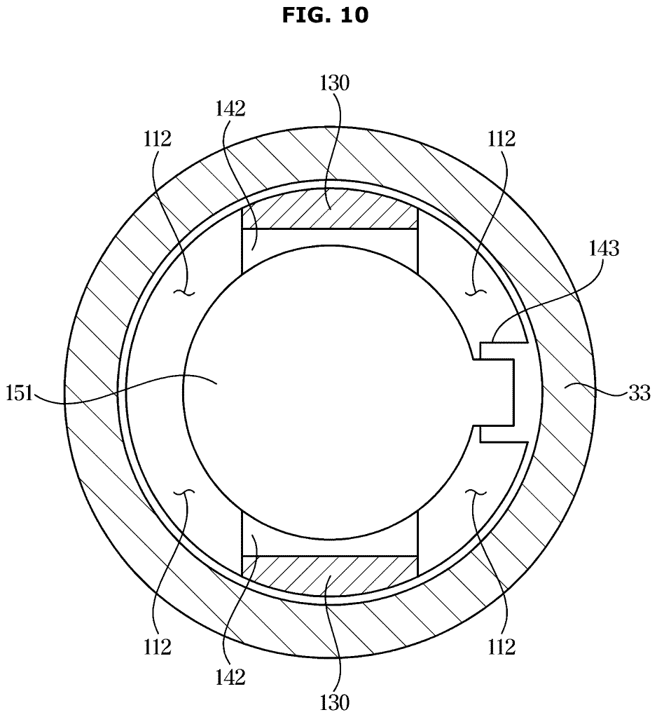

The separation space 112, which is a sufficient space for refrigerant to flow, may be formed when the plate 151 is moved toward the outlet protrusion 142 without contacting the inlet protrusion 122 (see FIG. 10).

FIG. 6 is an exploded plan view of the check valve 100 applied to the refrigerator 1 according to one or more embodiments of the present disclosure.

The valve housing 110 may include the side opening 111 formed to allow the core 150 to be inserted between the outlet body 140 and the inlet body 120, in a direction in which the guide groove 143 is formed relative to the connecting body 130.

The core 150 may be assembled to be arranged on the inner side of the valve housing 110 through the side opening 111 in the order of the plate 151 to the guide groove 143. The side opening 111 may be coupled such that the core 150 may not be disassembled from the valve housing 110 when the check valve 100 is inserted into the outlet pipe 33.

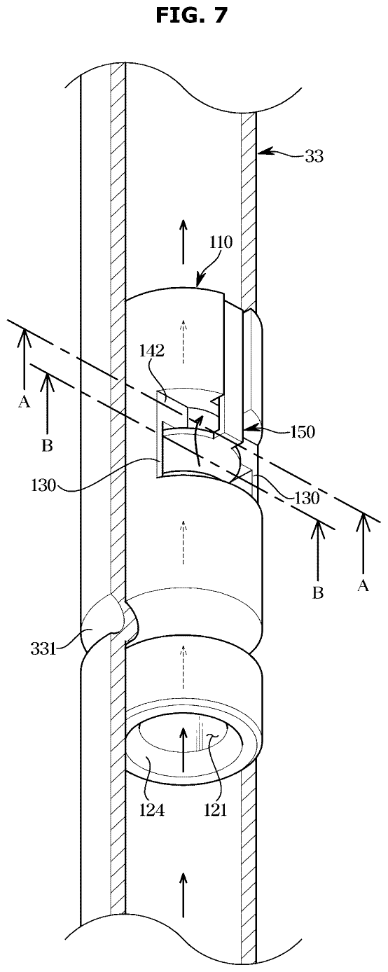

FIG. 7 is a partial cross-sectional view showing refrigerant flowing in a forward direction in the check valve 100 applied to the refrigerator 1 according to one or more embodiments of the present disclosure.

When no refrigerant is flowing, or when a very small amount of refrigerant is present in the outlet pipe 33, the core 150 may contact the inlet protrusion 122 by gravity, thereby blocking the refrigerant flow path 40. When a sufficient amount of refrigerant passes through the first evaporator 31, refrigerant may flow into the check valve 100 through the inlet 121.

In a case where the inlet 121 is small, the outer surface of the valve housing 110 formed around the inlet 121 may be subjected to pressure from the refrigerant when the refrigerant flows in, causing damage to the check valve 100 or the outlet pipe 33, or impeding the flow of the refrigerant.

To prevent such a condition, an inlet side of the inlet body 120 may be formed with an inclined surface 124 in which the flow path narrows progressively from the inlet 121 toward the inlet protrusion 122. This may allow the check valve 100 to operate smoothly.

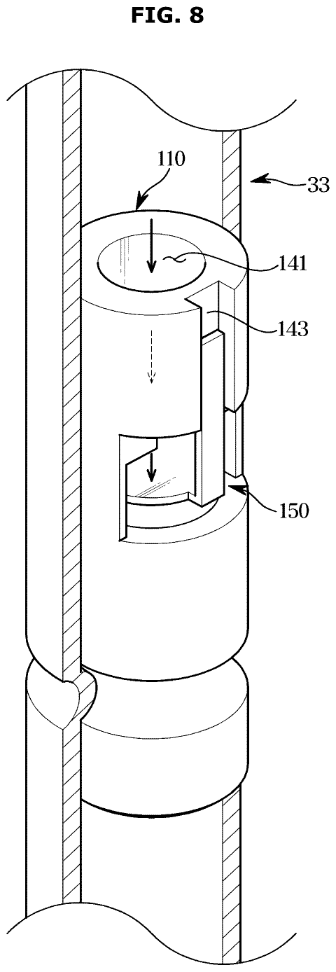

FIG. 8 is a partial cross-sectional view showing refrigerant flowing in a reverse direction in the check valve 100 according to one or more embodiments of the present disclosure. FIG. 8 is a view showing a state in which the flow path is closed such that the plate 151 of the core 150 is in contact with the inlet protrusion 122 of the inlet body 120 to prevent refrigerant from flowing into the flow path formed in the inlet body 120.

When the pressure of the refrigerant on the outlet body 140 side is greater than that on the inlet body 120 side, and refrigerant flows in a direction from the outlet to the inlet, no refrigerant may flow into the flow path formed in the inlet body 120 because the plate 151 in contact with the inlet protrusion 122 blocks the inlet of the flow path formed at an end of the inlet protrusion 122. In this case, the core 150 may be subject to the pressure of refrigerant that is opposite to gravity.

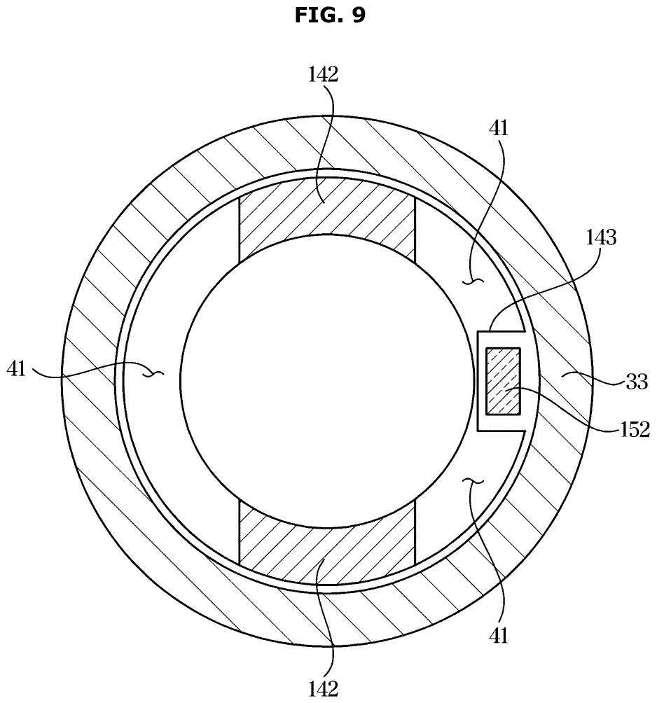

FIG. 9 is a cross-sectional view taken along line A-A of FIG. 7. When the outlet protrusion 142 is formed in a pipe shape like the inlet protrusion 122 and contacts the plate 151, refrigerant may not be able to flow through the guide channel 40 to the outlet 141.

To address such a problem, the outlet protrusion 142 may be formed in a shape having a plurality of protrusions configured to be connected to the connecting body 130. A space may be created in the valve housing 110 between each of the plurality of protrusions to form an intermediate flow path 41 through which the refrigerant may flow.

The refrigerant that has passed through the intermediate flow path 41 may be discharged toward the compressor 2 through the outlet 141.

FIG. 10 is a cross-sectional view taken along line B-B of FIG. 7. FIG. 10 is a cross-sectional view shown based on a line including the plate 151 of the check valve 100, where the plate 151 contacts the outlet protrusion 142 to allow refrigerant to flows in the forward direction.

Referring to FIG. 10, the valve housing 110 may be formed with the separation space 112 between the outer circumferential surface of the plate 151 and the outer surface of the valve housing 110 in the cross-sectional view. The separation space 112 may allow refrigerant flow from the inlet 121 to the outlet 141.

The refrigerator 1 according to one or more embodiments of the present disclosure may include: the main body 10 including the freezing compartment 21 and the refrigerating compartment 22; the compressor 2; the condenser 3; the first evaporator 31 provided in the freezing compartment 21 to cool the freezing compartment 21; the second evaporator 32 provided in the refrigerating compartment 22 to cool the refrigerating compartment 22; the outlet pipe 33 connected to an outlet of the first evaporator 31 and configured to transfer a refrigerant passing through the first evaporator 31 to the compressor 2; and the check valve 100 provided in the outlet pipe 33 and configured to prevent backflow from the outlet pipe 33 to the first evaporator 31, wherein the check valve 100 may include the valve housing 110 including the inlet 121, the outlet 141, and the guide channel 40 through which a refrigerant flows, and the core 150 configured to move back and forth in the valve housing 110 to allow a flow of the refrigerant from the inlet 121 to the outlet 141 and to block a flow of the refrigerant from the outlet 141 to the inlet 121, wherein the valve housing 110 may include the side opening 111 formed on a side surface of the valve housing 110, and at least a portion of the core 150 may be received in the guide channel 40 of the valve housing 110 through the side opening 111. With such a configuration, it is possible to provide the refrigerator 1 including a simplified check valve 100 with a simple configuration and easy assembly, and to improve cooling efficiency by preventing the phenomenon of refrigerant backflow in the outlet pipe 33 of the evaporator 30 with the lower pressure among the plurality of evaporators 30 with different evaporation pressures.

The inlet 121 may be disposed closer to the bottom surface 14 of the main body than the outlet 141. With such a configuration, the core 150 may efficiently block the flow path when the refrigerant flows in reverse under the influence of gravity.

The valve housing 110 may include the inlet body 120 in which the inlet 121 is formed, the outlet body 140 in which the outlet 141 is formed, and the connecting body 130 configured to connect the inlet body 120 and the outlet body 140.

The core 150 may include the plate 151 configured to be able to contact the inlet body 120, and the guide pin 152 protruding from the plate 151 in a direction toward the outlet 141.

The outlet body 140 may include the guide groove 143 formed on an outer surface of the outlet body 140 to receive the guide pin 152.

The inlet body 120 may include the inlet protrusion 122 formed to protrude in a direction toward the outlet body 140 and configured to be able to contact the plate 151, and an inner diameter of the guide channel 40 at an end of the inlet protrusion 122 may be smaller than a diameter of the plate 151.

The outlet body 140 may include the outlet protrusion 142 extending from the connecting body 130 and configured to be able to contact the plate 151.

The outlet protrusion 142 may include the plurality of protrusions spaced apart from each other at certain intervals, and the guide channel may include the intermediate flow path 41 formed to allow the refrigerant to flow between each of the plurality of protrusions.

The connecting body 130 may include the first connecting body 131 and the second connecting body 132, and the diameter of the plate 151 may be smaller than a distance between the first connecting body 131 and the second connecting body 132.

The inlet body 120 may include the inclined surface 124 whose diameter decreases progressively in a direction from the inlet 121 toward the inlet protrusion 122. With such a configuration, the flow of the refrigerant flowing into the inlet 121 may be unimpeded and smooth.

The core 150 may be formed of a silicone material. With such a configuration, noise generated by the collision between the valve housing 110 and the core 150 when the flow path is opened or closed may be reduced.

The inlet body 120 may include the coupling groove 123 formed as a groove along a perimeter of the inlet body 120 such that the check valve 100 may be coupled inside the outlet pipe 33.

The guide pin 152 may be configured to move back and forth in a space formed between an inner surface of the outlet pipe 33 corresponding to the guide groove 143 and the guide groove 143.

The outlet pipe 33 may include the sealing portion 331 corresponding to the coupling groove 123 to fix the check valve 100.

The valve housing 110 and the core 150 may be formed of different materials.

The check valve 100 according to one or more embodiments the present disclosure may include: the valve housing 110 including the inlet 121 through which refrigerant flows in, the outlet 141 through which refrigerant flows out, the inlet body 120 including the inlet 121, the outlet body 140 including the outlet 141, the connecting body 130 configured to connect the inlet body 120 and the outlet body 140, the side opening 111 formed between the outlet body 140 and the inlet body 120, and the guide channel 40 through which refrigerant flows; and the core 150 including the plate 151 configured to be able to contact the inlet body 120 and the guide pin 152 connected to the plate 151, wherein at least a portion of the core may be configured to be received in the guide channel 40 through the side opening 111, wherein the outlet body 140 may include the guide groove 143 formed on an outer surface of the outlet body 140 to receive the guide pin 152 and allow the guide pin 152 to move back and forth. With such a configuration, the simplified check valve 100 with a simple configuration and easy assembly may be provided.

The inlet body 120 may include the inlet protrusion 122 formed to protrude in a direction toward the outlet body 140 and configured to be able to contact the plate 151, and an inner diameter of the guide channel 40 at an end of the inlet protrusion 122 may be smaller than a diameter of the plate.

The core may be formed of a silicone material. With such a configuration, noise generated by the collision between the valve housing 110 and the core 150 when the flow path is opened or closed may be reduced.

The inlet body 120 may include the coupling groove 123 in which a groove is formed along a perimeter of the inlet body 120.

The inlet body 120 may include the inclined surface 124 whose diameter narrows progressively in a direction from the inlet 121 toward the outlet 141.

The effects to be obtained from the present disclosure are not limited to the effects mentioned above, and other unmentioned effects can be clearly understood by those of ordinary skill in the art to which the present disclosure pertains from the description below. While the present disclosure has been described with reference to exemplary embodiments, it should be understood by those of skilled in the art that various changes in form and details may be made without departing from the spirit and scope of the present disclosure.

What is claimed is:

1. A refrigerator comprising:
a main body comprising a freezing compartment and a refrigerating compartment;
a compressor;
a condenser;
a first evaporator provided in the freezing compartment and configured to cool the freezing compartment;
a second evaporator provided in the refrigerating compartment and configured to cool the refrigerating compartment;
an outlet pipe connected to an outlet of the first evaporator and configured to transfer a refrigerant passing through the first evaporator to the compressor; and
a check valve provided in the outlet pipe and configured to prevent backflow from the outlet pipe to the first evaporator,
wherein the check valve comprises:
a valve housing comprising an inlet, an outlet, and a guide channel through which the refrigerant flows; and
a core configured to move back and forth in the valve housing to allow a flow of the refrigerant from the inlet to the outlet and to block a flow of the refrigerant from the outlet to the inlet,
wherein the valve housing comprises a side opening on a side surface of the valve housing, and
wherein at least a portion of the core is received in the guide channel of the valve housing through the side opening.

2. The refrigerator of claim 1, wherein the inlet is closer to a bottom surface of the main body than the outlet.

3. The refrigerator of claim 2, wherein the valve housing comprises:
an inlet body in which the inlet is formed;
an outlet body in which the outlet is formed; and
a connecting body connecting the inlet body and the outlet body.

4. The refrigerator of claim 3, wherein the core comprises:
a plate configured to be contactable with the inlet body; and
a guide pin protruding from the plate in a direction toward the outlet.

5. The refrigerator of claim 4, wherein the outlet body comprises a guide groove on an outer surface of the outlet body to receive the guide pin.

6. The refrigerator of claim 5, wherein the inlet body comprises an inlet protrusion formed to protrude in a direction toward the outlet body and configured to contact the plate, and
wherein an inner diameter of the guide channel at an end of the inlet protrusion is smaller than a diameter of the plate.

7. The refrigerator of claim 6, wherein the outlet body comprises an outlet protrusion extending from the connecting body and configured to contact the plate.

8. The refrigerator of claim 7, wherein the outlet protrusion comprises a plurality of protrusions spaced apart from each other at certain intervals, and
wherein the guide channel comprises an intermediate flow path configured to allow the refrigerant to flow between each of the plurality of protrusions.

9. The refrigerator of claim 6, wherein the connecting body comprises a first connecting body and a second connecting body, and
wherein the diameter of the plate is smaller than a distance between the first connecting body and the second connecting body.

10. The refrigerator of claim 6, wherein the inlet body comprises an inclined surface having a diameter that decreases progressively in a direction from the inlet toward the inlet protrusion.

11. The refrigerator of claim 9, wherein the core comprises a silicone material.

12. The refrigerator of claim 5, wherein the inlet body comprises a coupling groove along a perimeter of the inlet body such that the check valve is to be coupled to an interior of the outlet pipe.

13. The refrigerator of claim 12, wherein the guide pin is configured to move back and forth in a space formed between an inner surface of the outlet pipe corresponding to the guide groove and the guide groove.

14. The refrigerator of claim 13, wherein the outlet pipe comprises a sealing portion corresponding to the coupling groove to fix the check valve.

15. The refrigerator of claim 11, wherein the valve housing and the core comprises different materials.
